(19) United States
(12) Patent Application Publication
(10) Pub. No.: US 2025/0198474 A1
(43) Pub. Date: Jun. 19, 2025

(54) BRAKE APPARATUS FOR AN ELECTRIC FINAL DRIVE APPARATUS, AND ELECTRIC FINAL DRIVE APPARATUS HAVING A BRAKE APPARATUS

(71) Applicant: Schaeffler Technologies AG & Co. KG, Herzogenaurach (DE)

(72) Inventors: Simon Ortmann, Pulheim (DE); Claudia Seiter, Bühlertal (DE)

(73) Assignee: Schaeffler Technologies AG & Co. KG, Herzogenaurach (DE)

(21) Appl. No.: 18/847,320

(22) PCT Filed: Feb. 28, 2023
(86) PCT No.: PCT/DE2023/100159

§ 371 Date: Sep. 16, 2024

(30) Foreign Application Priority Data
Mar. 17, 2022 (DE) 10 2022 106 270.8

(51) Int. Cl. F16D 65/18; B60T 1/06; F16D 55/02; F16D 121/04; F16D 127/02

(52) U.S. Cl. CPC F16D 65/186; B60T 1/065; F16D 55/02; F16D 2121/04; F16D 2127/02

(57) ABSTRACT

A brake apparatus for an electric final drive apparatus includes
a movement device for moving a connecting device of the brake apparatus, with the aid of which the brake apparatus is frictionally connectable to a vehicle wheel or to a transmission device of an electric final drive apparatus in order to decelerate a vehicle wheel or the transmission device.
The movement device includes at least one piston unit with the aid of which a connecting device of the brake apparatus can be moved.
a supply device for supplying a pressurizable fluid to the movement device.
The supply device has a fluid-conducting unit that conducts a pressurizable fluid to the at least one piston unit such that a pressurizable fluid can be supplied to the at least one piston unit.
The fluid-conducting unit has a fluid-conducting channel and an inlet.
The fluid-conducting channel is formed as a groove and fluidically connects the inlet to the at least one piston unit.

### CROSS-REFERENCE TO RELATED APPLICATIONS

This application is the U.S. National Phase of PCT Appln. No. PCT/DE2023/100159 filed Feb. 28, 2023, which claims priority to DE 10 2022 106 270.8 filed Mar. 17, 2022, the entire disclosures of which are incorporated by reference herein.

### TECHNICAL FIELD

The disclosure relates to a brake apparatus for an electric final drive apparatus and an electric final drive apparatus for driving one or more vehicle wheels of an electric or hybrid vehicle.

### BACKGROUND

From DE 10 2019 201 989, there is known an electric final drive apparatus which, in addition to a transmission for converting the torque of an electric machine, has a brake apparatus (cf. FIG. 2 of DE 10 2019 201 989).

The brake apparatus 30 can reduce the speed of the electric machine 12. For this purpose, a second axially movable pressure plate 36 is actuated via a ring actuator 52, which can position the second axially movable pressure plate 36 against a braking element 32 of the brake apparatus 30. From the other side of the braking element 32, a first pressure plate 34 can be adjusted, which is stationary in the housing 10.

In such a brake apparatus, the supplying of the ring actuator with pressurized fluid is a laborious solution. This is because a pressurized fluid is usually fed to the ring actuator via one or more drilled supply channels to displace the piston thereof. These drilled supply channels must be connected to each other and then partially closed, since no pressurized fluid should escape at the entry point of the drill. The entry point is only caused by the production process to create optimally running supply channels. This method of production is cost-intensive.

As a result, a corresponding material depth is required to produce boreholes. This in turn increases the weight.

### SUMMARY

It is therefore an object of the present disclosure to provide a brake apparatus for an electric final drive apparatus and an electric final drive apparatus for driving one or more vehicle wheels of an electric or hybrid vehicle, which can be produced simply and thus cost-effectively and in a material-saving manner to reduce weight and save energy.

This object is achieved by the features o described in the claims, description and drawings. Further advantageous developments are the subject matter of the claims, description and drawings.

A first aspect of the present disclosure comprises a brake apparatus for an electric final drive apparatus.

The brake apparatus comprises a movement device for moving a connecting device of the brake apparatus, with the aid of which the brake apparatus is frictionally connectable to a vehicle wheel or to a transmission device of an electric final drive apparatus. This allows a vehicle wheel or the transmission to be slowed down. The connecting device can frictionally connect the brake apparatus, which can be arranged fixedly in a housing of an electric final drive apparatus, to a rotating part of an electric final drive apparatus, such as, for example, to a vehicle wheel or to a rotating subcomponent of a transmission device of the electric final drive apparatus. In this way, a vehicle wheel or rotating component can be slowed down.

The movement device comprises at least one piston unit, with the aid of which a connecting device of the brake apparatus can be moved.

Furthermore, the brake apparatus has a supply device for supplying the movement device with a pressurizable fluid.

The supply device has a fluid-conducting unit which conducts a pressurizable fluid to the at least one piston unit, so that the at least one piston unit can be supplied with a pressurizable fluid. As a result, a piston of the at least one piston unit can be displaced or moved.

The fluid-conducting unit comprises a fluid-conducting channel and an inlet, wherein the fluid-conducting channel is formed as a groove and fluidically connects the inlet to the at least one piston unit. A groove offers the advantage that it can be produced easily and cost-effectively, as well as saving material.

In this description, the term “groove” is given the meaning commonly used in technical jargon-namely, “groove” is to be understood as an elongated recess in a component, made on a surface of the component.

A groove can have a rectangular cross-section or a trapezoidal shape, with an outward-sloping wall or as a dovetail. Furthermore, a groove can be produced, for example, using a milling machine.

The supply device, e.g., the fluid-conducting unit thereof and/or the closure unit thereof, can be made of a metal such as aluminum or steel.

Furthermore, the fluid-conducting channel can follow the course of the supply device. Furthermore, the fluid-conducting channel can have a curved course and/or a circular ring-shaped course.

In addition, the supply device can comprise a closure unit which is arranged on the fluid-conducting unit to close the fluid-conducting channel. Thus, for example, the fluid-conducting unit, which can be provided with a fluid-conducting channel formed as a groove, can be closed in a simple manner so that the fluid-conducting channel of the fluid-conducting unit can conduct a pressurizable fluid.

The closure unit can comprise at least one seal to close the fluid-conducting channel at the transition to the fluid-conducting unit in a fluid-tight manner. The at least one seal can be arranged within at least one sealing groove of the closure unit.

The closure unit and the fluid-conducting unit can be fastened to each other, e.g., by means of screws.

The supply device can be formed as a circular ring-shaped disc.

The closure unit and/or the fluid-conducting unit can be formed as a circular ring-shaped disc.

Furthermore, the fluid-conducting unit or the closure unit for the at least one piston unit of the movement device can comprise at least one supply channel which fluidically connects the fluid-conducting channel to a pressure chamber of the at least one piston unit.

The at least one supply channel can be formed as a borehole that penetrates the fluid-conducting unit or the closure unit completely, or from a first side to a second side of the fluid-conducting unit or the closure unit. This means that at least one supply channel can be manufactured quickly, easily, and precisely.

Furthermore, the fluid-conducting unit or the closure unit can comprise at least one seal to close the at least one supply channel at the transition to the at least one piston unit in a fluid-tight manner. The at least one seal can be arranged within a sealing groove of the fluid-conducting unit or the closure unit.

In addition, the fluid-conducting unit or the closure unit can have a first and a second side. The at least one piston unit of the movement device can be arranged on the first side. The second side can have the fluid-conducting channel. Furthermore, one sealing groove per seal of the fluid-conducting unit can also be arranged on the first side. In addition, the closure unit can be arranged on the second side.

In addition, the fluid-conducting unit or the closure unit can comprise an outlet for heat dissipation of a pressurizable fluid.

The inlet and/or outlet can be formed by means of at least one borehole.

Furthermore, the inlet and/or outlet can be formed by two boreholes that intersect each other, e.g., at a vertical angle.

The inlet and/or outlet can also have a connection opening to which the brake apparatus can be connected to a fluid supply system.

The part or area of the fluid-conducting unit or the closure unit with the inlet and/or outlet can have a greater material thickness than the part or area of the fluid-conducting unit with the fluid-conducting channel.

The inlet and/or outlet can further be fluidically connected to the fluid-conducting channel, so that pressurizable fluid can flow into the supply device through the inlet and, after flowing through the fluid-conducting channel, can flow out through the outlet.

Furthermore, the at least one piston unit can have a housing and a piston moveable therein. The housing can have a cylindrical cavity within which the piston is moveable. A pressure chamber can be formed between the piston and the housing. The piston can be displaced from a retracted state to an extended state and vice versa, whereby in the extended state the pressure chamber has a larger volume than in the retracted state. Furthermore, the housing can be attached to the supply device or to the fluid-conducting unit thereof, e.g., by means of screws.

The piston can comprise a piston element for contacting the connecting device of the brake apparatus. The piston element can have a seal for sealing the pressure chamber and/or a sliding band for improved displaceability or movability of the piston relative to the housing or within the housing.

Furthermore, the piston can comprise a conducting element. The pressure chamber can be formed between the conducting element and the housing. The conducting element serves to improve the guidance of the piston within the housing or within the cylindrical cavity of the housing and to simplify the insertion thereof into the cavity.

The piston element and the conducting element can be fastened to each other, e.g., by means of a screw.

The at least one piston unit can comprise a bellows which is attached to the piston or to the piston element thereof and the housing to prevent the penetration of undesirable fluids or particles between the housing and the piston.

The movement device can, for example, comprise at least one spring holder per piston unit, which can be connected, e.g., screwed, to a housing of the at least one piston unit. A bellows of the at least one piston unit can be clamped between the at least one spring holder and a housing of the at least one piston unit.

The movement device can, for example, comprise at least one spring plate and at least one return element per piston unit, both of which are movable relative to at least one spring holder of the movement device.

The at least one spring plate and the at least one return element can be rigidly connected to one another, e.g., by means of screws. The at least one return element can contact a piston of the at least one piston unit, for example on the piston element thereof, to return the piston from an extended state to a retracted state.

In addition, the movement device can comprise, for example, at least one spring element per piston unit, which is arranged between at least one spring plate of the movement device and at least one spring holder of the movement device to return at least one return element of the movement device to the starting position. In the initial position, the movement device exerts no or only a very small force on the connecting device so that the latter cannot frictionally connect the brake apparatus to a vehicle wheel or to a transmission device of an electric final drive apparatus to slow down a vehicle wheel or the transmission device.

The movement device can comprise a plurality of piston units or at least two piston units which are evenly distributed along the spatial course of the connecting device to move the connecting device evenly and without tilting.

Furthermore, the connecting device can comprise a pressure distribution unit which distributes the acting pressure, generated by movement of the at least one piston unit, evenly along the spatial course of the pressure distribution unit. The pressure distribution unit can have a shape similar to a hollow cylinder or a shape similar to a circular ring-shaped disc. The pressure distribution unit can also comprise a receiving area for arranging lamella elements to a non-rotating or rotationally fixed part of a multiple disc brake.

A second aspect of the present disclosure comprises an electric final drive apparatus.

It is expressly stated that the characteristics of the brake apparatus mentioned in the first aspect can be applied individually or in combination with the electric final drive device.

In other words, the features mentioned above under the first aspect of the disclosure concerning the brake apparatus can also be combined with other features under the second aspect of the disclosure.

An electric final drive apparatus for driving one or more vehicle wheels of an electric or hybrid vehicle comprises a brake apparatus according to the first aspect.

Furthermore, the final drive device can comprise an electric machine and a transmission device connected to the electric machine, wherein the transmission device can be connected to one or more vehicle wheels.

The electric machine and/or the transmission device can comprise multiple disc elements to realize a rotating part of a multiple disc brake.

The brake apparatus with the connecting device thereof and the transmission device and/or the electric machine can be operatively connected so that a ring gear or a planet carrier or a sun gear or a shaft or a gear of the transmission device and/or the electric machine can be slowed down.

In the following, the principle or inventive idea of the disclosure described above is expressed again and in other words in a supplementary manner.

This idea relates-presented in simplified form-to a brake apparatus for an electric final drive apparatus with a fluid-conducting channel which is formed on the one hand by a groove in a fluid-conducting unit and which is closed on the other hand by a closure unit, so that the fluid-conducting channel can be formed to be fluid-tight.

In other words, a housing part of the brake apparatus or a housing of at least one piston unit of a movement device of the brake apparatus, which ensures the fluid supply to at least one piston unit of a movement device of the brake apparatus, can be manufactured simply and thus cost-effectively and in a material-saving manner. At the same time, this can reduce the weight of the brake apparatus to save energy.

Furthermore, at least one piston unit of a movement device of the brake apparatus, in which a pressure chamber can be formed, can be manufactured as an extruded profile, for example, in a very material-saving and cost-saving manner.

### BRIEF DESCRIPTION OF THE DRAWINGS

The disclosure will be explained in more detail below using an exemplary embodiment in conjunction with associated drawings. In the schematic drawings:

FIG. 1A and 1B show a spatial front and rear view of a brake apparatus for an electric final drive apparatus;

FIG. 2 shows a plan view of the front and a sectional view along B-B;

FIG. 3 shows an enlarged sectional view of a region from FIG. 2;

FIG. 4 shows a spatial representation of the brake apparatus from Figure IA with a section along A-A from FIG. 2 and;

FIG. 5 shows a sectional view along C-C from FIG. 2.

### DETAILED DESCRIPTION

In the description below, the same reference symbols are used for the same components.

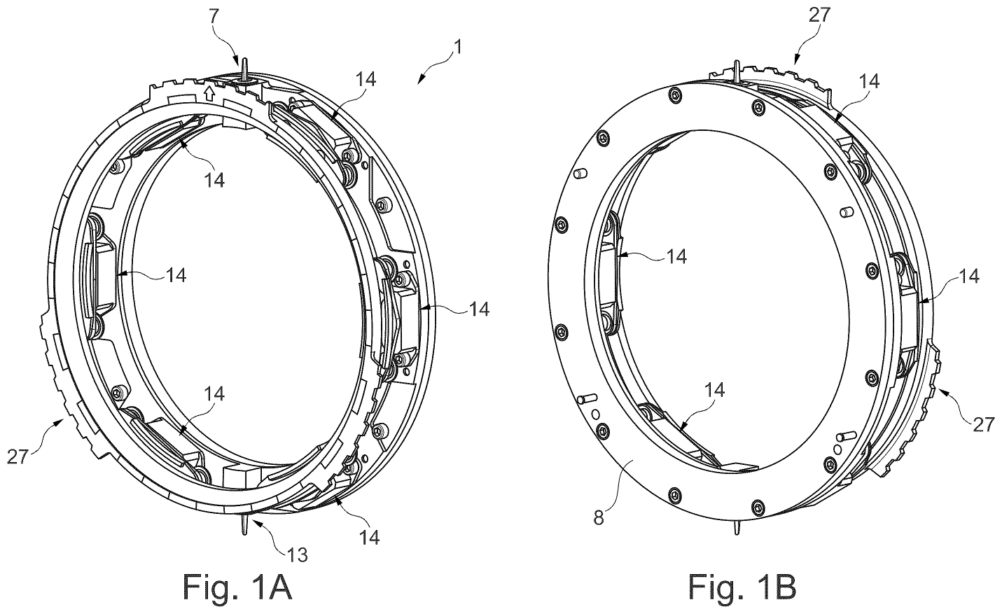

FIGS. 1A and 1B show a spatial front and rear view of a brake apparatus 1 for an electric final drive apparatus.

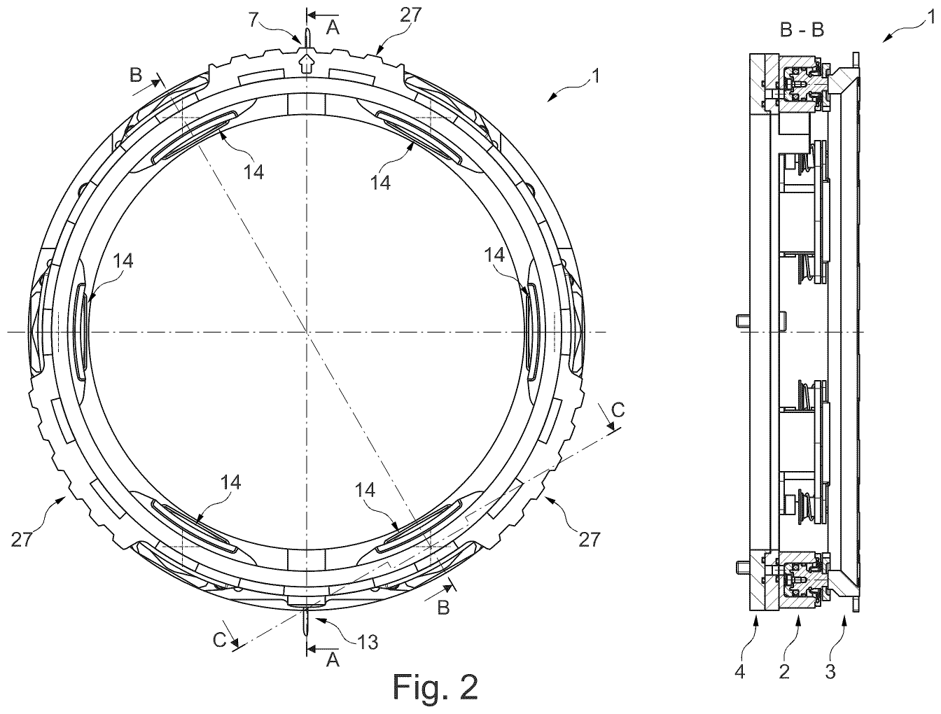

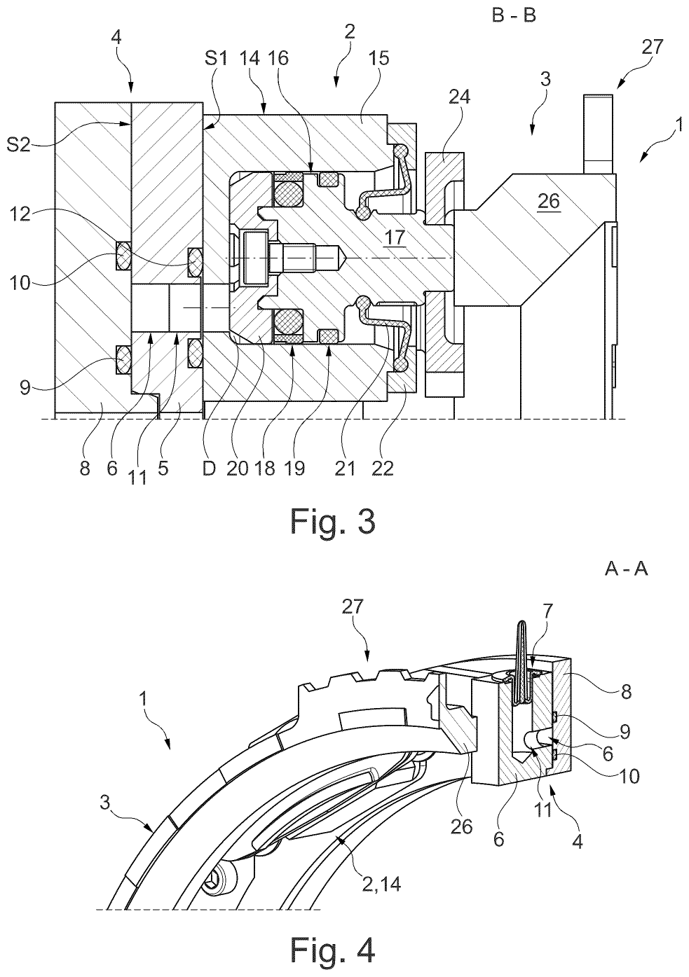

FIG. 2 shows a plan view of the front and a sectional view along B-B, with FIG. 3 showing an enlarged sectional view of a portion of FIG. 2.

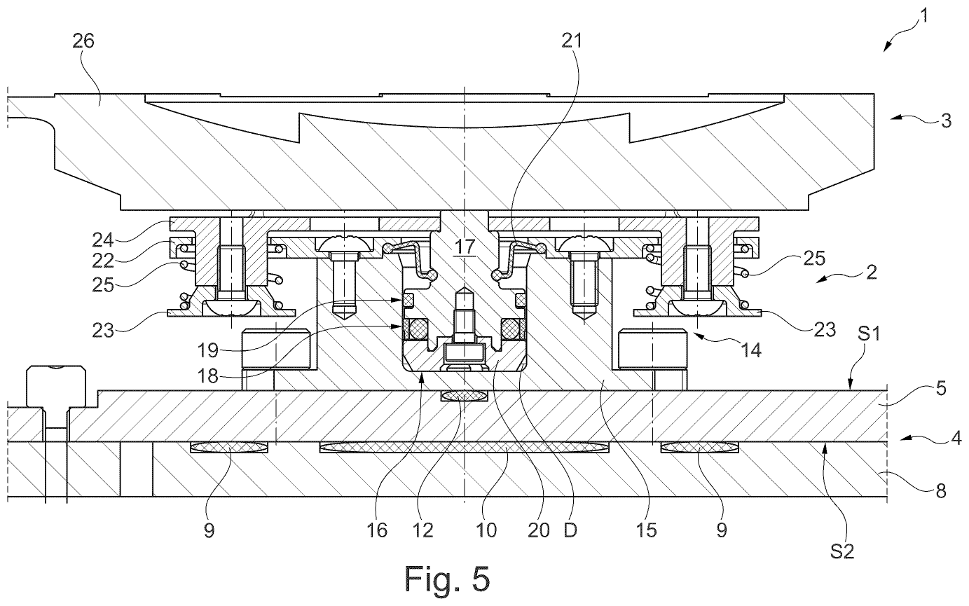

FIG. 4 shows a spatial representation of the brake apparatus 1 with a section along A-A from FIG. 2 and FIG. 5 shows a sectional view along C-C from FIG. 2.

FIGS. 1A to 5 are described together below for brevity and simplicity. Attention is drawn to figures in which the features described below are particularly well illustrated.

FIGS. 1A to 5 show a brake apparatus 1 for an electric final drive apparatus.

According to FIGS. 3 and 5, the brake apparatus 1 has a movement device 2 for moving a connecting device 3 of the brake apparatus 1, with the aid of which the brake apparatus 1 is frictionally connectable to a vehicle wheel or to a transmission device of an electric final drive apparatus to slow down a vehicle wheel or the transmission device. The connecting device 3 can frictionally connect the brake apparatus 1, which can be arranged fixedly in a housing of an electric final drive apparatus, to a rotating part of an electric final drive apparatus, such as, for example, to a vehicle wheel or to a rotating subcomponent of a transmission device of the electric final drive apparatus. In this way, a vehicle wheel or rotating component can be slowed down.

The movement device 2 has six piston units 14 (cf. FIGS. 1A, 1B, 2), with the aid of which a connecting device 3 of the brake apparatus 1 can be moved.

Furthermore, the figures show that the brake apparatus 1 comprises a supply device 4 for supplying the movement device 2 with a pressurizable fluid.

According to FIG. 3, the supply device 4 has a fluid-conducting unit 5 which conducts a pressurizable fluid to the piston units 14 so that the piston units 14 can be supplied with a pressurizable fluid. This allows one piston 16 of each piston unit 14 to be displaced.

The fluid-conducting unit 5 has a fluid-conducting channel 6 and an inlet 7, wherein the fluid-conducting channel 6 is formed as a groove and fluidically connects the inlet 7 with each piston unit 14 (cf. FIGS. 3 and 4).

As indicated in FIGS. 1A to 5 and as can be seen particularly in FIG. 4, the fluid-conducting channel 6 follows the course of the supply device 4, wherein the fluid-conducting channel 6 has a curved course or a circular ring-shaped course.

Furthermore, FIGS. 3 and 5 show that the supply device 4 has a closure unit 8 which is arranged on the fluid-conducting unit 5 to close the fluid-conducting channel 6.

The closure unit 8 has two seals 9, 10 (see FIGS. 3, 4 and 5) to seal in a fluid-tight manner the fluid-conducting channel 6 at the transition to the fluid-conducting unit 5.

Each seal 9, 10 is arranged within a sealing groove of the closure unit 8 (see FIGS. 3 to 5), wherein the closure unit 8 and the fluid-conducting unit 5 are fastened to one another by means of screws (see FIGS. 1A, 1B and 5).

Furthermore, it is shown in all figures that the supply device 4 is formed as a circular ring-shaped disc. In other words, the closure unit 8 and the fluid-conducting unit 5 are formed as a circular ring-shaped disc.

As indicated in FIG. 3, the fluid-conducting unit 5 has a supply channel 11 for each piston unit 14 of the movement device 2, which fluidically connects the fluid-conducting channel 6 with a pressure chamber D of the piston unit 14.

The supply channel 11 is formed as a borehole which penetrates the fluid-conducting unit 5 completely or from a first side S1 to a second side S2 of the fluid-conducting unit 5.

According to FIGS. 3 and 5, the fluid-conducting unit 5 has several seals 12 to close each supply channel 11 at the transition to the piston unit 14 in a fluid-tight manner. Each seal 12 is arranged within a sealing groove of the fluid-conducting unit 5.

As already indicated and shown in FIGS. 3 and 5, the fluid-conducting unit 5 has a first and a second side S1, S2, wherein the piston units 14 of the movement device 2 are arranged on the first side S1.

Strictly speaking, the piston units 14 of the movement device 2 and one sealing groove per seal 12 of the fluid-conducting unit 5 are arranged on the first side S1.

On the second side S2, however, the closure unit 8 is arranged. Furthermore, the second side S2 has the fluid-conducting channel 6 (see FIGS. 3 and 5).

Looking at FIGS. 1A, 1B, 2, and 4, it can be seen that in addition to the fluid-conducting channel 6 and the inlet 7, the fluid-conducting unit 5 comprises an outlet 13 for heat dissipation of a pressurizable fluid.

The inlet and outlet 7, 13 are formed by two boreholes which intersect each other at a vertical angle (see FIG. 4). The inlet and outlet 7, 13 each have a connection opening to which the brake apparatus I can be connected to a fluid supply system. Closures are inserted within the connection openings of the inlet and outlet 7, 13 in FIGS. 1A to 5.

The part or area of the fluid-conducting unit 5 with the inlet and outlet 7, 13 has a greater material thickness than the part or area of the fluid-conducting unit 5 with the fluid-conducting channel 6.

The inlet and outlet 7, 13 are connected in a fluid-communicating manner to the fluid-conducting channel 6 (see, for example, FIG. 4) so that pressurizable fluid can flow into the supply device 4 through the inlet 7 and, after flowing through the fluid-conducting channel 6, can flow out through the outlet 13. In this way, heat generated in the piston units 14 during deceleration can be dissipated.

In FIGS. 3 and 5, it is shown by way of example on a piston unit 14 that each piston unit 14 has a housing 15 and a piston 16 which can be moved therein.

The housing 15 has a cylindrical cavity within which the piston 16 can be moved. A pressure chamber D is formed between the piston 16 and the housing 15. The piston 16 can be displaced from a retracted state (shown in all figures) to an extended state and vice versa, wherein in the extended state the pressure chamber D has a larger volume than in the retracted state.

The housing 15 is fastened to the supply device 4 or to the fluid-conducting unit 5 thereof by means of screws (see e.g., FIG. 5).

The piston 16 has a piston element 17 for contacting the connecting device 3 of the brake apparatus 1, wherein the piston element 17 has a seal 18 for sealing the pressure chamber D and a sliding band 19 for improved displaceability of the piston 16 relative to the housing 15.

Furthermore, FIGS. 3 and 5 show that the piston 16 comprises a conducting element 20, wherein the pressure chamber D is formed between the conducting element 20 and the housing 15. The conducting element 20 serves to improve the guidance of the piston 16 within the housing 15 or within the cylindrical cavity of the housing 15 and to simplify the insertion thereof into the cavity. The piston element 17 and the conducting element 20 are fastened to each other by means of a screw.

Each piston unit 14 further has a bellows 21 which is attached to the piston 16 or to the piston element 17 thereof and the housing 15 to prevent the penetration of undesirable fluids or particles between the housing 15 and the piston 16.

Furthermore, FIGS. 3 and 5 show that the movement device 2 comprises one spring holder 22 per piston unit 14, which is screwed to the housing 15 of the piston unit 14. A bellow 21 is clamped between the spring plate 22 and the housing 15.

In addition (see FIGS. 3 and 5), the movement device 2 has two spring plates 23 and one return element 24 per piston unit 14, both of which are movable relative to the spring holder 22 of the movement device 2.

The two spring plates 23 and the return element 24 are rigidly connected to each other by means of screws. The return element 24 is in contact with the piston 16 of the piston unit 14 or with the piston element 17 thereof to return the piston 16 from an extended state to a retracted state.

Furthermore, the movement device 2 has two spring elements 25 per piston unit 14, which are arranged between a spring plate 23 and the spring holder 22 to return the return element 24 to the initial position thereof. In the initial position, the movement device 2 exerts no or only a very small force on the connecting device 3, so that the latter cannot frictionally connect the brake apparatus 1 to a vehicle wheel or to a transmission device of an electric final drive apparatus to slow down a vehicle wheel or the transmission device.

As already mentioned, the movement device 2 has a plurality of piston units 14, namely six, which are evenly distributed along the spatial course of the connecting device 3 to be able to move the connecting device 3 evenly and without tilting (see, for example, FIGS. 1A to 2).

Furthermore, FIGS. 3 and 5 show that the connecting device 3 has a pressure distribution unit 26 which distributes the acting pressure, generated by movement of the piston units 14, evenly along the spatial course of the pressure distribution unit 26.

The pressure distribution unit 26 has a shape similar to a hollow cylinder or a shape similar to a circular ring-shaped disc, wherein the pressure distribution unit 26 comprises a receiving area 27 for the arrangement of disc elements to realize a non-rotating or rotationally fixed part of a disc brake.

The brake apparatus 1 presented above can be used, for example, in an electric final drive apparatus for driving one or more vehicle wheels of an electric or hybrid vehicle.

In such a case, for example, the final drive apparatus has, in addition to the brake apparatus 1, as shown above, an electric machine and a transmission device connected to the electric machine.

The transmission device can be connectable to one or more vehicle wheels, wherein the transmission device can comprise disc elements to realize a rotating part of a disc brake.

Furthermore, the brake apparatus 1 with the connecting device 3 thereof and the transmission device can be operatively connected so that a ring gear of the transmission device can be slowed down.

In the following, FIGS. 1A to 5 are described again in different words.

Roughly summarized, each housing 15 of a piston unit 14 has a borehole on the underside.

To ensure the supply of a pressurizable fluid to each housing 15 of a piston unit 14, a ring-shaped assembly or a supply device 4 is mounted underneath, consisting of two components screwed together and sealed together (housing distributor or fluid-conducting unit 5 and housing cover or closure unit 8).

In the fluid-conducting unit 5, a channel or a fluid-conducting channel 6 is introduced as a groove, which together with transverse boreholes or supply channels 11 ensures the distribution of a pressurizable fluid to the individual piston units 14.

The sealing between the fluid-conducting unit 5 and the closure unit 8 is carried out by means of two seals 9, 10 or O-rings or similar sealing bodies. The sealing between the housings 15 and the housing distributor or the fluid-conducting unit 5 is also provided by small ring-shaped sealing rings or seals 12.

In a special version of the arrangement shown, the O-rings or seals 9, 10 can be omitted. For this purpose, the housing distributor or the fluid-conducting unit 5 and the housing cover or the closure unit 8 are fused together and manufactured using an additive (3D printing) process.

### List of Reference Symbols

1 Brake device
2 Movement device
3 Connecting device
4 Supply device
5 Fluid-conducting unit
6 Fluid-conducting channel
7 Inlet
8 Closure unit
9 Seal
10 Seal
11 Supply channel
12 Seal
13 Outlet
14 Piston unit
15 Housing
16 Piston
17 Piston element
18 Seal
19 Sliding band
20 Conducting element
21 Bellows
22 Spring plate
23 Spring plate
24 Return element
25 Spring element
26 Pressure distribution unit
27 Receiving region
D Pressure chamber
S1 First side
S2 Second side

1. A brake apparatus for an electric final drive apparatus comprising:
a movement device for moving a connecting device of the brake apparatus, with the aid of which the brake apparatus is frictionally connectable to a vehicle wheel or to a transmission device of the electric final drive apparatus to slow down the vehicle wheel or the transmission device,
wherein the movement device comprises at least one piston unit with the aid of which a connecting device of the brake apparatus can be moved, and
a supply device for supplying the movement device with a pressurizable fluid, wherein:
the supply device has a fluid-conducting unit which conducts a pressurizable fluid to the at least one piston unit so that the at least one piston unit can be supplied with a the pressurizable fluid,
wherein the fluid-conducting unit comprises a fluid-conducting channel and an inlet,
wherein the fluid-conducting channel is formed as a groove and connects the inlet with the at least one piston unit in a fluid-communicating manner.

2. The brake apparatus according to claim 1,
wherein the fluid-conducting channel has a curved or circular ring-shaped course.

3. The brake apparatus according to claim 1,
wherein the supply device has a closure unit which is arranged on the fluid-conducting unit to close the fluid-conducting channel.

4. The brake apparatus according to claim 3,
wherein the fluid-conducting unit or the closure unit for the at least one piston unit of the movement device has at least one supply channel which fluidically connects the fluid-conducting channel with a pressure chamber of the at least one piston unit.

5. The brake apparatus according to claim 3,
wherein the fluid-conducting unit or the closure unit has a first and a second side,
wherein the at least one piston unit of the movement device is arranged on the first side, and
wherein the closure unit is arranged on the second side.

6. The brake apparatus according to claim 1,
wherein the at least one piston unit has a housing and a piston moveable therein,
wherein the housing has a cylindrical cavity within which the piston is moveable.
wherein a pressure chamber is formed between the piston and the housing,
wherein the housing is attached to the supply device or to the fluid-conducting unit thereof, and
wherein the piston comprises a piston element for contacting the connecting device of the brake apparatus.

7. The brake apparatus according to claim 1,
wherein the movement device comprises at least one spring plate per piston unit, which is connected, e.g.,
wherein the movement device comprises at least one return element, the at least one spring plate and the at least one return element are movable relative to at least one spring holder of the movement device, and
wherein the movement device comprises at least one spring element per piston unit, which is arranged between the at least one spring plate of the movement device and the at least one spring holder of the movement device to return the at least one return element of the movement device to a starting position.

8. The brake apparatus according to claim 1,
wherein the movement device comprises a plurality of piston units or at least two piston units which are evenly distributed along a spatial course of the connecting device to move the connecting device evenly and without tilting.

9. The brake apparatus according to claim 1,
wherein the connecting device comprises a pressure distribution unit which distributes an acting pressure, generated by movement of the at least one piston unit, evenly distributed along a spatial course of the pressure distribution unit.

10. An electric final drive apparatus for driving one or more vehicle wheels of an electric or hybrid vehicle, comprising:
a brake apparatus according to claim 1.
